(19) United States
(12) Patent Application Publication
(10) Pub. No.: US 2009/0267340 A1
(43) Pub. Date: Oct. 29, 2009

(54) PRINT CATALOG WITH IMAGES USED TO CONVEY INFORMATION

(75) Inventor: Geoffry A. Westphal, Park Ridge, IL (US)

Correspondence Address: GREENBERG TRAURIG, LLP, 77 WEST WACKER DRIVE, SUITE 3100, CHICAGO, IL, 60601-1732, US

(73) Assignee: W.W. GRAINGER, INC., Lake Forest, IL (US)

(21) Appl. No.: 12/111,452

(22) Filed: Apr. 29, 2008

(51) Int. Cl. B42D 15/00

(52) U.S. Cl. 283/56

(57) ABSTRACT

A print catalog has a plurality of pages that are bound together with a binding. Each page of the print catalog has a listing of one or more products that are being offered for sale and at least one non-textual image that is representative of a category of product for products within the listing of products on that page. The non-textual image on each of the plurality of pages is positioned on a side of its respective page that is spaced furthest from the binding.

### BACKGROUND

Print catalogs are known in the art. By way of example, a well known, print catalog is provided by W. W. Grainger, Inc. (“Grainger”). The “Grainger” catalog currently includes approximately 4000 pages of products that are offered for sale by “Grainger.” To allow a user to find a product of interest, the “Grainger” catalog includes a product/page index, a manufacturer & brand/page index, and a stock keeping unit (SKU)/page index. In addition, the “Grainger” catalog includes tabs each having a textual description that is used to denote the start of a section of the “Grainger” catalog, e.g., “HVAC/R: Fans, Blowers, A/C & Refrigeration, Air Filters, Heating.” Each section of the “Grainger” catalog includes pages having products of a uniform predetermined type and each page within each section similarly includes a textual description that is used to convey information concerning the products that are presented on that page, e.g., “A/C Refrigeration” and “Room Air Conditioners, Heat Pumps, & Accessories.” An example of such a page from the “Grainger” catalog is shown in prior art FIG. 1.

### SUMMARY

A print catalog has a plurality of pages that are bound together with a binding. Each page of the print catalog has a listing of one or more products that are being offered for sale and at least one non-textual image that is representative of a category of product for products within the listing of products on that page. The non-textual image on each of the plurality of pages is positioned on a side of its respective page that is spaced furthest from the binding, i.e., the part of the page that is visible when the pages of a catalog are quickly flipped through.

A better understanding of the objects, advantages, features, properties and relationships of the inventive print catalog described hereinafter will be obtained from the following detailed description and accompanying drawings which set forth an illustrative embodiment of the subject invention.

### BRIEF DESCRIPTION OF THE DRAWINGS

For a better understanding of the inventive print catalog described hereinafter, reference may be had to the following drawings in which:

FIG. 1 illustrates a prior art, print catalog page;

FIG. 2 illustrates an exemplary, print catalog page having an image which is used to convey information in accordance with a preferred embodiment of the invention; and

FIG. 3 illustrates an exemplary, print catalog page having multiple images which are used to convey information in accordance with a preferred embodiment of the invention.

### DETAILED DESCRIPTION

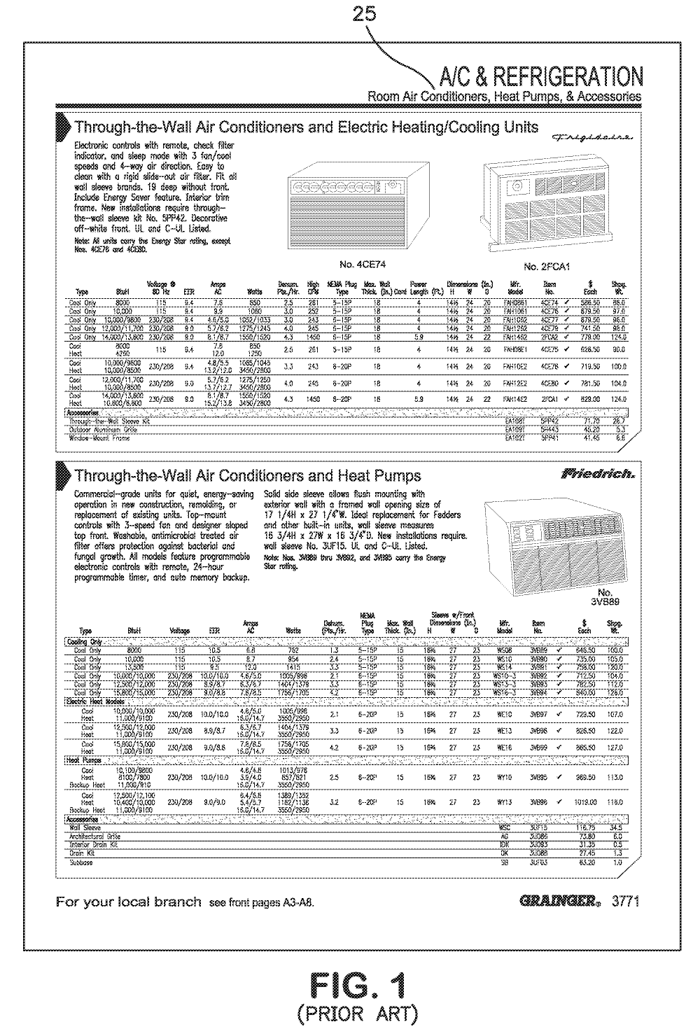

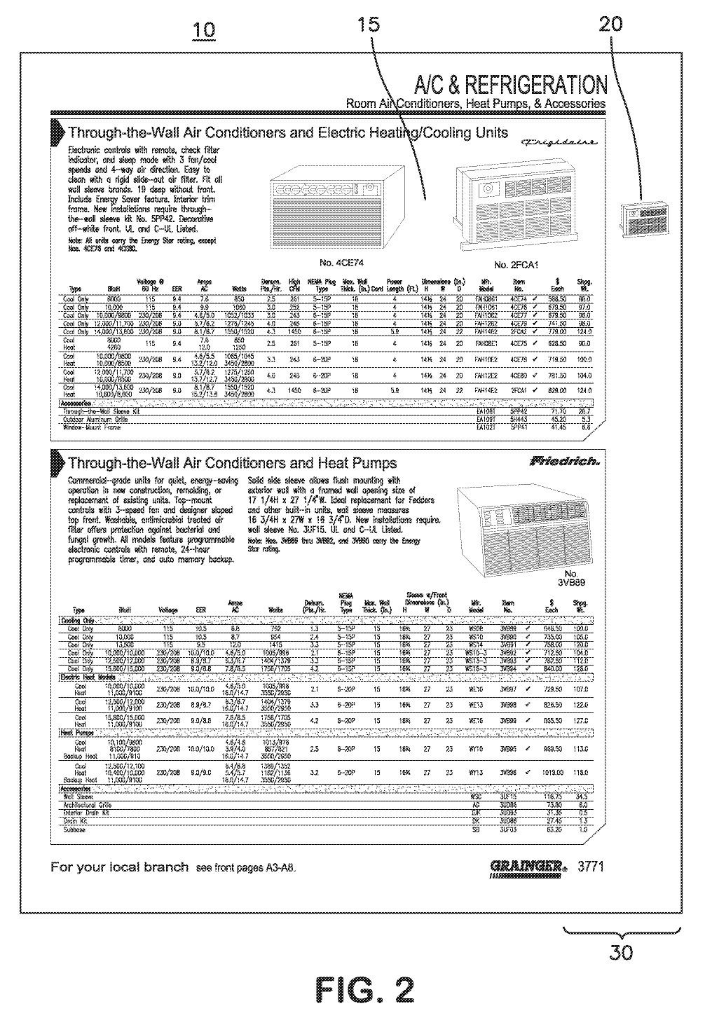

Turning to the drawings an exemplary, print catalog page 10 having one or more images 20 is shown in FIG. 2. The image 20 that is presented on the print catalog page 10 is selected to convey information to a user concerning the product(s) that are to be found on that print catalog page 10. In this regard, it is to be appreciated that a user will be able to more quickly find a particular product of interest when browsing the catalog and viewing the images 20 on the print pages 10 of the catalog as compared to browsing a catalog having textual page labels, such as shown in FIG. 1, for the reason that image information is generally processed more quickly by an individual as compared to information conveyed via text.

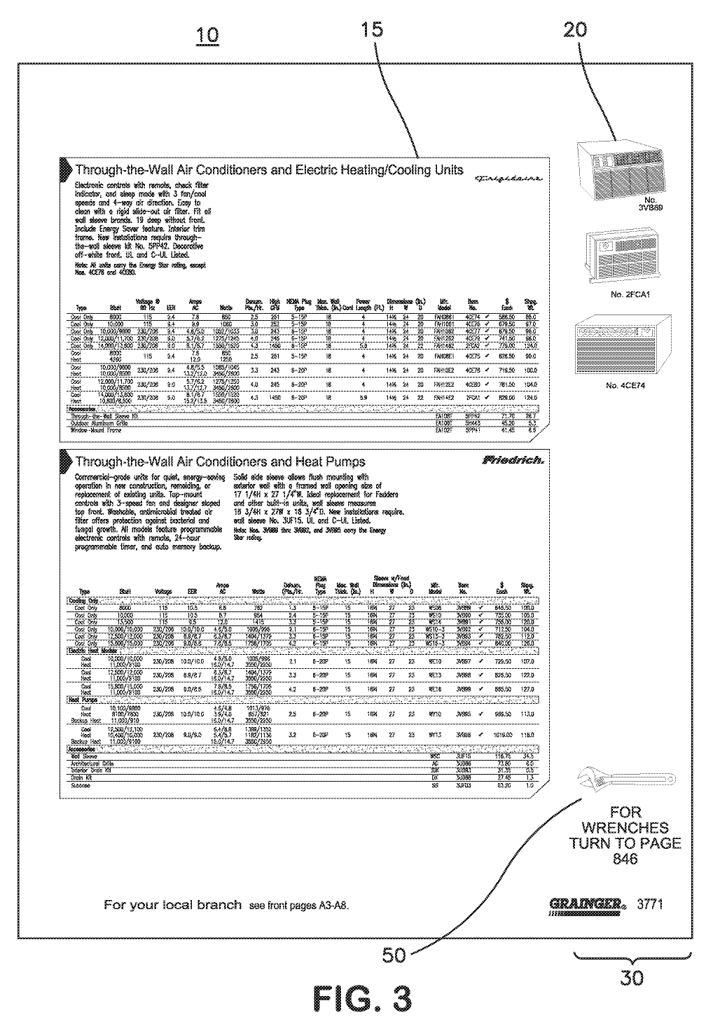

To facilitate browsing of the print catalog, the image 20 that is to be provided on each page of the print catalog is preferred to be an image that is representative of a category of product(s) that is being offered for sale on that particular catalog page 10. Thus, for this purpose, the image 20 provided on each catalog page may be a photographic image of a product that is being offered for sale on that catalog page 10—such as the photographic image of the product corresponding to SKU No. 2FCA1 shown in exemplary FIGS. 2 and 3—a drawing of a product that is being offered for sale on that catalog page 10, etc. Furthermore, in the event that multiple categories of products are being offered for sale on a single catalog page, it will be appreciated that multiple, corresponding, representative images 20 may be placed on that catalog page 10 as particularly illustrated in FIG. 3.

To additionally assist a user in quickly locating a product of interest, the images 20 on each catalog page 10 are preferably positioned adjacent to the listing of products 15 that are being offered for sale on a side 30 of the catalog page 10 that is furthest removed from the binding of the print catalog and the images 20 are also preferably provided with a size, such as 1 inch×1 inch, so as to be visible and discemable even when the pages of the print catalog are being flipped through quickly by a user. In the example illustrated in FIG. 2, the image 20 representative of the products that are being offered for sale on the relevant catalog page 10 is positioned in the vicinity of the upper middle portion of the side 30 of the catalog page 10. In the example illustrated in FIG. 3, the images 20 are located along the side of the page opposite the binding with product images being further removed from the textual, listing of products 15 which textual, listing of products would not be readily visible during a flipping of the catalog pages. In this manner, a user is able to quickly flip through the pages of the print catalog, for example by thumbing through the pages, and will be able to stop the page flipping process upon seeing the image 20 that corresponds to the product for which the user was searching or otherwise finds of interest.

While not required, the images 20 representative of the one or more products that are being offered for sale are preferably positioned at the same relative location on each page of the entirety of a print catalog or at least in the same relative location on each page that is within a predetermined section of a print catalog. Furthermore, it will be appreciated that, while FIGS. 2 and 3 illustrate an image 20 being used in lieu of a textual page label, an image 20 may be used in conjunction with a textual page label, such as the textual page label 25 shown in prior art FIG. 1. Yet further, it will be appreciated that the catalog may have products arranged alphabetically by product name, by category, or by the like and each page may include at least one product image 20 for a product that starts with an appropriate letter that is positioned on a side of each page of the catalog furthest from the binding to facilitate a user quickly finding a product of interest via an image scanning, flipping operation. Still further, the catalog can be arranged as illustrated in FIG. 3 with a product image 20 being used to depict a category of product(s) on a given catalog page (for example being positioned on a top, outer side of the page) with each page further having a product image 50 and an accompanying page indicator (for example positioned on a bottom, outer side of the page) where product images 50 are used to provide an alphabetically arranged, page flipable product index, e.g., an image of a caster and page indicator would be near the front of the catalog, an image of a ladder and page indicator would be near the middle of the catalog, and an image of a wrench and page indicator would be near the end of the catalog. Accordingly, while specific embodiments of the invention have been described in detail, it will be appreciated by those skilled in the art that various modifications and alternatives to those details could be developed in light of the overall teachings of the disclosure and, as such, the particular arrangement disclosed is meant to be illustrative only and not limiting as to the scope of the invention which is to be given the full breadth of the appended claims and any equivalents thereof.

What is claimed is:

1. A print catalog, comprising:
a plurality of pages bound together with a binding, each of the plurality of pages having a listing of one or more products that are being offered for sale and at least one non-textual image that is representative of a category of product for products within the listing of products that is being offered for sale on each respective one of the plurality of pages wherein the at least one non-textual image on each of the plurality of pages is positioned adjacent to the listing of one or more products that are being offered for sale on a side of the respective one of the plurality of pages that is spaced furthest from the binding.

2. The print catalog as recited in claim 1, wherein the non-textual image comprises a photographic image.

3. The print catalog as recited in claim 1, wherein each of the plurality of pages further includes at least one textual label representative of the category of product for products within the listing of products that is being offered for sale on each respective one of the plurality of pages.

4. The print catalog as recited in claim 1, wherein the non-textual image on each of the plurality of pages is positioned in the same general location on the side of the respective one of the plurality of pages that is spaced furthest from the binding.

5. The print catalog as recited in claim 1, wherein the plurality of pages comprises a section of the print catalog.

6. The print catalog as recited in claim 5, wherein the section of the print catalog comprises listings of products having a uniform, predetermined product classification.

7. The print catalog as recited in claim 6, wherein the section of the print catalog comprising listings of products is free of product images.

8. The print catalog as recited in claim 1, wherein each of the plurality of pages has an index image with an associated page listing upon which one or more products that are being offered for sale and related to the index image are to be found.

9. The print catalog as recited in claim 8, wherein the index images are arranged throughout the catalog alphabetically according to letters for a descriptor for a product shown in the index image.

10. The print catalog as recited in claim 8, wherein the index image on each of the plurality of pages is positioned adjacent to the listing of one or more products that are being offered for sale on the side of the respective one of the plurality of pages that is spaced furthest from the binding.

11. The print catalog as recited in claim 10, wherein the index image and the non-textual image on each of the plurality of pages are positioned near respective corners of each of the plurality of pages adjacent to the listing of one or more products that are being offered for sale on the side of the respective one of the plurality of pages that is spaced furthest from the binding.

12. The print catalog as recited in claim 8, wherein the index image on each of the plurality of pages comprises a photographic image.
